(19) United States
(12) Patent Application Publication
(10) Pub. No.: US 2025/0015980 A1
(43) Pub. Date: Jan. 9, 2025

(54) SYSTEMS AND METHODS FOR SECURE KEY DISTRIBUTION VIA A DRONE MESH NETWORK

(71) Applicant: Wells Fargo Bank, N.A., San Francisco, CA (US)

(72) Inventors: Jeff J. Stapleton, O'Fallon, MO (US); Peter Bordow, Fountain Hills, AZ (US)

(21) Appl. No.: 17/661,481

(22) Filed: Apr. 29, 2022

(51) Int. Cl. H04L 9/08; B64C 39/02

(52) U.S. Cl. CPC H04L 9/0852; B64C 39/024; H04L 9/0822; H04L 9/0869; B64U 2101/20

(57) ABSTRACT

Systems, apparatuses, methods, and computer program products are disclosed for facilitating extended range encrypted communication. An example method includes automatically navigating, via navigation circuitry of a first drone, to a first location of a first device. The example method also includes generating, by quantum random number generator circuitry of the first drone, a cryptographic key. The example method also includes establishing, by communications hardware of the first drone, a first connection between the first drone and the first device. The example method also includes causing transmission, by the communications hardware of the first drone, of the cryptographic key to the first device, such that the cryptographic key facilitates secure communication between the first drone and the first device.

### BACKGROUND

For purposes of increased security, cryptographic symmetric keys are often hand-delivered to devices (e.g., via a key loading device). However, this method of delivery becomes impractical in instances in which the devices are separated by a great distance and/or located in dangerous and/or extremely remote areas.

### BRIEF SUMMARY

In some examples, cryptographic keys may be generated and distributed to devices via a process known as Quantum Key Distribution (QKD). In a traditional QKD implementation, a QKD device generates two streams of quantum entangled particles (e.g., photons) and sends one stream to a first device (Alice) and another to a second device (Bob). Typically, one of the participants manages the QKD device, but it could be managed by a third party. Alice and Bob both read the received entangled particles, interpreting the same string of binary zeroes and ones. Alice and Bob can use a separate communications channel to statistically verify that they have read and interpreted the entangled particles correctly. A device reading any photon will affect the state of that photon, so through a variety of operations, Alice and Bob are able to determine whether an attacker (e.g., Eve) using a third device has intercepted any of the transmitted photons. As a result, Alice and Bob are able to use only photons that were not intercepted as the basis for generation of a key known only to each other. That key can then be used for secure communications. However, such implementations of QKD require dedicated equipment with clear and reliable channels for network communication, including agreed-upon protocols and processes, and thus are not readily applicable for situations in which secret cryptographic keys must be exchanged between remote locations.

Accordingly, most distributions of cryptographic keys today rely upon other methods. For instance, many cryptographic keys are injected into devices within a Key Injection Facility (KIF), which is a physically secure room. After receipt of one or more secret keys within a KIF, a device can thereafter be shipped to remote locations where it can utilize the injected keys. To facilitate this process, such devices often include a Secure Cryptographic Device (SCD) that provides physically and logically protected cryptographic services and storage (e.g., a PIN entry device (PED) or Hardware Security Module (HSM)) into which the secret key(s) are injected. For instance, an SCD may be integrated into a larger system such as an automated teller machine (ATM) or point-of-sale (POS) terminal, and after injection of one or more secret keys into the integrated SCD, the larger system may thereafter be deployed to its ultimate destination for use in commerce.

Another common method for exchange keys today uses a portable Key Loading Device (KLD), which is a mobile device that can physically transport and inject keys outside of a key injection facility (KIF). Keys are prepared at the KIF and transferred to the KLD. The KLD is then physically transported (e.g., carried by a human) to a remote device and the prepared keys are transferred to an SCD of the remote device. Thus, secure communication between the remote device and a host device may be established. However, ground transportation of keys inside a KLD increases the risk of the keys becoming compromised if the KLD is stolen.

Further, in some instances, the remote device may be inaccessible to a human carrying the KLD. For example, dangerous terrain may surround the remote device, the remote device may be located in an area currently experiencing extreme environmental conditions (e.g., wildfires, deep freeze, etc.), the remote device may be located in an active combat zone, the remote device may be located a great distance away from the KIF and/or a host device with which the remote device is to communicate, and/or the like. In this regard, it may be impractical and in some cases impossible for a human to physically deliver keys to the remote device via a KLD. Accordingly, the inventors have realized that a need exists for new solutions that improve upon traditional tools for secret key exchange that gains the benefits of quantum-based key generation and existing KLD delivery methods, but that mitigates the various issues noted above.

Systems, apparatuses, methods, devices, and computer program products are disclosed herein for facilitating extended range encrypted communication. Example embodiments described herein leverage a connected “mesh” network of unmanned drones capable of generating symmetric keys in the form of truly random numbers by leveraging an onboard QRNG. In some examples, a drone may navigate (e.g., fly) to a first remote device, generate a cryptographic key, and securely provide the cryptographic key to the remote device. The drone may thereafter securely provide the cryptographic key to a host device, thus establishing a unique, secure key known to the host device and the remote device such that the devices may securely communicate with each other. Additionally, in some embodiments, the drone may inject unique cryptographic keys into a series of remote devices, and then may securely provide the cryptographic keys to the host device, thus enabling the host device and the series of remote devices to securely communicate with each other. Further, in some embodiments, a first drone may link with a second drone in the drone network and distribute one or more keys to the second drone. The second drone may then utilize the one or more keys to securely communicate with the first drone and/or the host device, or provide the one or more keys to other remote devices. Through the use of a drone network, cryptographic keys can be securely delivered to remote devices even in instances in which the environment conditions surrounding the remote devices render human delivery impossible. Further, delivery of cryptographic keys by drones may activate (or re-activate) communication between remote devices and a host device (e.g., in instances in which communication between the remote devices and host device is inactive and requires cryptographic keys to active). Additionally, in some embodiments, delivery of cryptographic keys by drones to various remote devices may enable the remote devices to securely communicate with each other locally (e.g., in instances in which communication to a host device is severed but the remote devices still have power and communicate locally).

In one example embodiment, a method is provided for facilitating extended range encrypted communication. The method includes automatically navigating, via navigation circuitry of a first drone, to a first location of a first device. The method also includes generating, by quantum random number generator circuitry of the first drone, a cryptographic key. The method also includes establishing, by communications hardware of the first drone, a first connection between the first drone and the first device. The method also includes causing transmission, by the communications hardware of the first drone, of the cryptographic key to the first device, such that the cryptographic key facilitates secure communication between the first drone and the first device.

In another example embodiment, an apparatus is provided for facilitating extended range encrypted communication. The apparatus includes navigation circuitry of a first drone configured to automatically navigate to a first location of a first device. The apparatus also includes quantum random number generator circuitry of the first drone configured to generate a cryptographic key. The apparatus also includes communications hardware of the first drone configured to establish a first connection between the first drone and the first device. The communications hardware is also configured to cause transmission of the cryptographic key to the first device, such that the cryptographic key facilitates secure communication between the first drone and the first device.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1A illustrates an example representation of facilitating extended range encrypted communication via one or more drones of a drone mesh network, in accordance with some example embodiments described herein.

FIG. 1B illustrates an example representation of facilitating extended range encrypted communication via one or more drones of a drone mesh network, in accordance with some example embodiments described herein.

FIG. 1C illustrates an example representation of facilitating extended range encrypted communication via one or more drones of a drone mesh network, in accordance with some example embodiments described herein.

FIG. 1D illustrates an example representation of facilitating extended range encrypted communication via one or more drones of a drone mesh network, in accordance with some example embodiments described herein.

FIG. 1E illustrates a system in which some example embodiments may be used for facilitating extended range encrypted communication, in accordance with some example embodiments described herein.

FIG. 2 illustrates a schematic block diagram of example circuitry embodying a drone that may perform various operations in accordance with some example embodiments described herein.

FIG. 3 illustrates an example flowchart for facilitating extended range encrypted communication, in accordance with some example embodiments described herein.

FIG. 4 illustrates an example flowchart for facilitating extended range encrypted communication, in accordance with some example embodiments described herein.

FIG. 5 illustrates another example flowchart for facilitating extended range encrypted communication, in accordance with some example embodiments described herein.

FIG. 6 illustrates a swim lane diagram of operations for facilitating extended range encrypted communication, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” or “device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

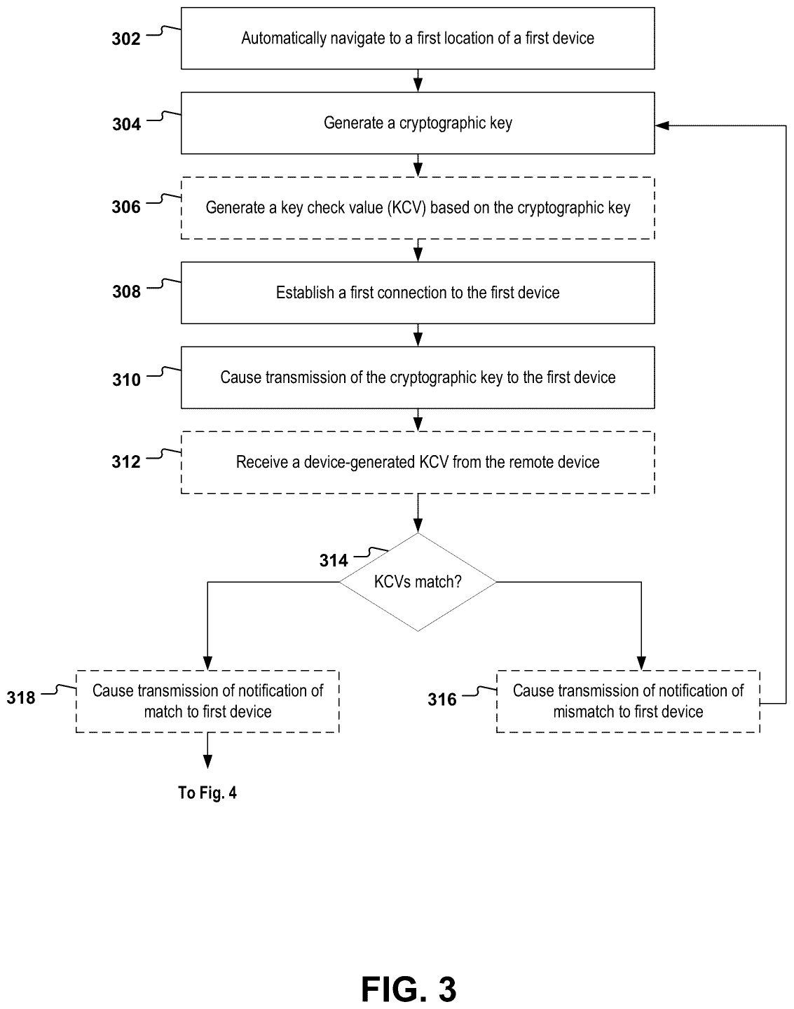

The term “drone” refers to an unmanned vehicle (e.g., an unmanned aerial vehicle (UAV)) which may be remote controlled or autonomous. A drone may include one or more connection ports or the like suitable to connect to other devices and transmit data (e.g., cryptographic keys) to the devices. For example, communications hardware of an example drone may comprise a connection port for a fiber-optic cable. As another example, an example drone may comprise a laser port. More broadly, a drone includes connection ports of one kind or another that are suitable to physically attach to devices and inject data (e.g., cryptographic keys) into the devices. In some embodiments, a drone may comprise an onboard quantum random number generator (QRNG) such that the drone may be configured to cryptographic keys (e.g., in the form of truly random numbers). Further, in some embodiments, a drone may be configured to carry other devices that store cryptographic keys (e.g., such as an HSM as described above) and deliver the devices to remote locations. These capabilities are further discussed below with reference to FIGS. 3-6.

### Overview

Methods, apparatuses, systems, and computer program products are described herein that facilitate extended range encrypted communication. As noted above, it is very difficult to securely distribute cryptographic keys in instances in which devices are located in remote or dangerous areas. Similarly, ground transportation of a KLD suffers from the potential compromise of keys that are stored within the KLD.

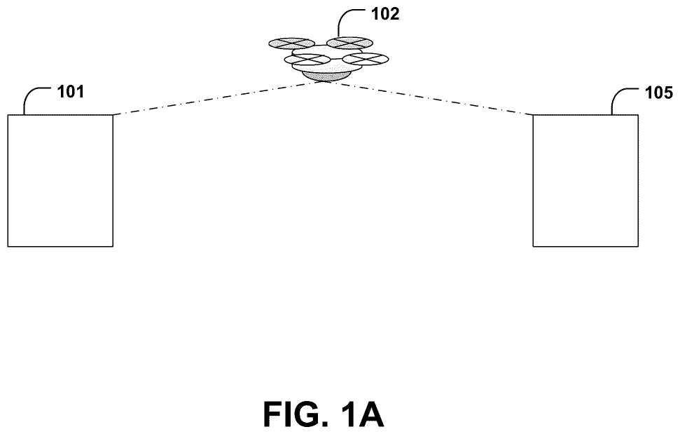

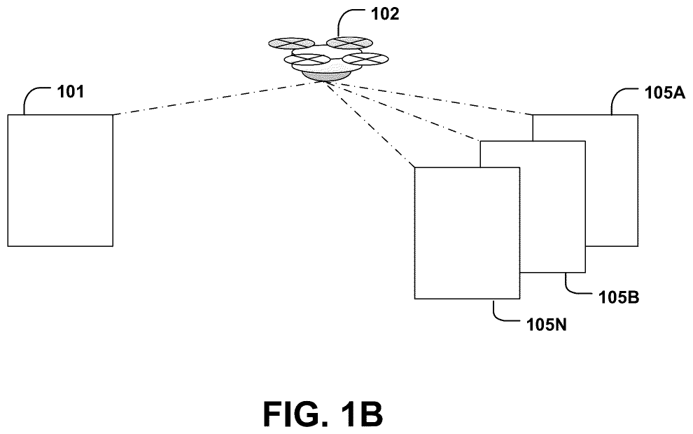

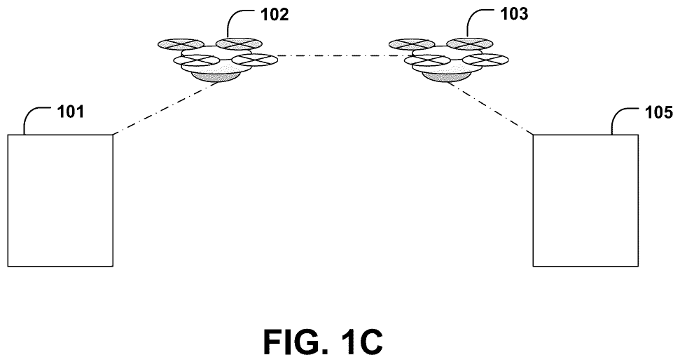

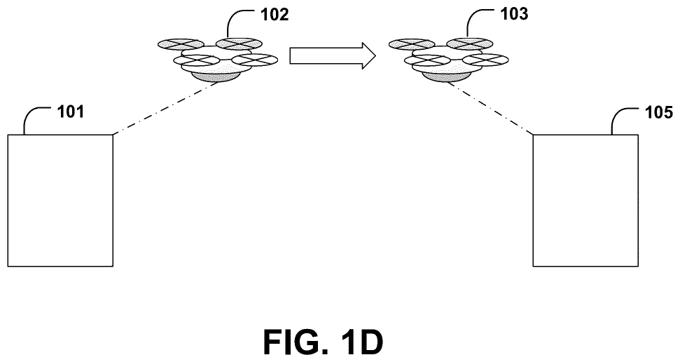

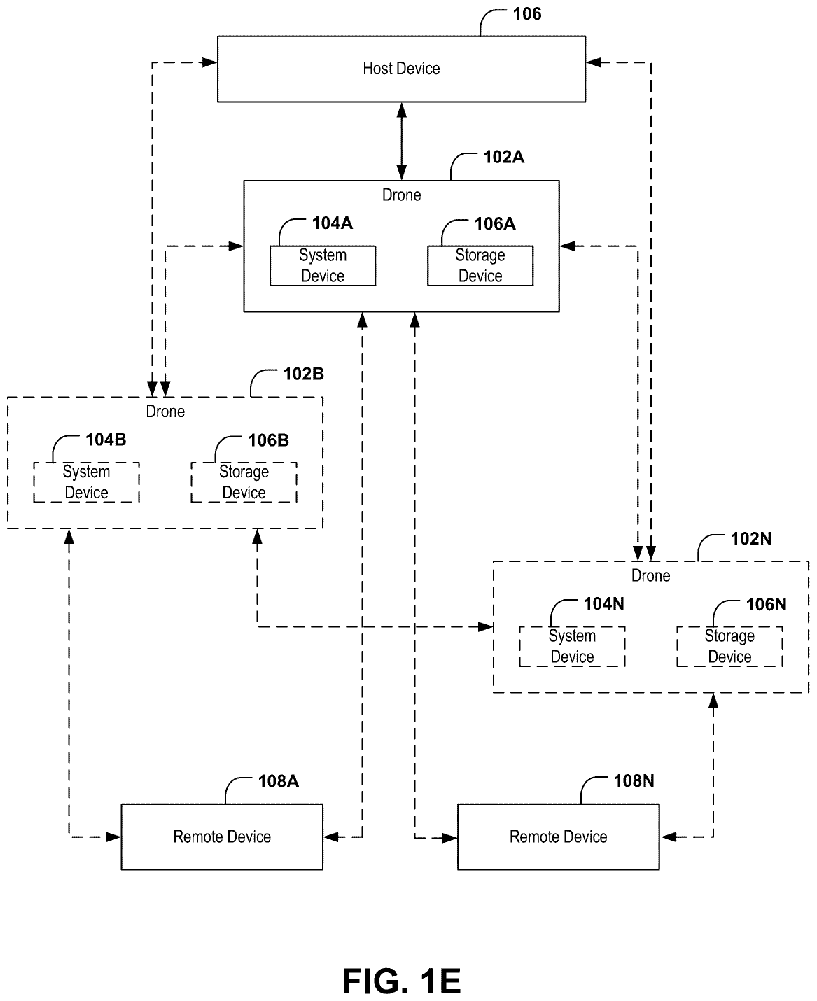

In contrast to conventional techniques for key distribution involving human delivery of keys via a KLD, example embodiments described herein leverage a connected “mesh” network of unmanned drones capable of generating symmetric keys in the form of truly random numbers by leveraging an onboard QRNG. In this regard, example embodiments utilize a plurality of drones to efficiently navigate to remote locations and leverage quantum-based hardware to generate and securely inject cryptographic keys into multiple devices across different remote locations and correspondingly securely provide the cryptographic keys to a host device. In various embodiments, the host device and drone network may establish a unique key per remote device and/or per drone for secure communications. Since only each remote device and the host have access to the corresponding cryptographic key, each respective device and the host can mutually authenticate using keys for which there is a high assurance level that no other party will be able to access. In this regard, in some embodiments, as a drone navigates from device to device, the drone may utilize an onboard QRNG to generate a secure key which is then injected into the device by the drone. As the drone may not generate the key until arriving at a respective remote device, this approach enables improved security over traditional methods while also allowing access to devices located in hard-to-reach locations and/or within extreme environments (e.g., via an unmanned aerial drone). To illustrate, FIGS. 1A-1D depict several example representations of how various drones of a drone network may deliver keys to host devices and remote devices.

FIG. 1A illustrates an example scenario in which a drone 102 may communicate with a host device 101 and a remote device 105. In this regard, the drone 102 may travel to a remote device 105, generate a cryptographic key and provide the cryptographic key to the remote device 105. The drone may then securely communicate the cryptographic key to the host device 101, such that the host device may securely communicate with the remote device.

FIG. 1B illustrates an example scenario in which a drone 102 may communicate with a host device 101 and multiple remote devices 105A, 105B, through 105N. In this regard, a drone 102 may generate a single cryptographic key and distribute the cryptographic key to multiple remote devices 105A-N, and then securely communicate the cryptographic key to the host device 101, such that the host device may securely broadcast data to the multiple remote devices 105A-N. In another embodiment, the drone 102 may generate multiple, unique keys for each of the multiple remote devices 105A-N, and securely communicate the cryptographic keys to the host device 101, such that the host device may securely communicate with each remote device individually.

FIG. 1C illustrates an example scenario in which a drone 102 may communicate with another drone 103 of a drone network in order to establish secure communication between a host device 101 and a remote device 105. In this regard, in some example embodiments, a first drone 102 may deliver a cryptographic key to a second drone 103 so the first drone and the second drone can communicate securely. In some embodiments, the second drone 103 may deliver another cryptographic key to a third drone (not shown), such that the second drone and the third drone can communicate securely, and so the first drone 102 and third drone can communicate securely via the second drone 103. This sequential process may continue indefinitely to produce an authenticated “mesh” of drones that can be leveraged to enable any endpoint remote device 105 and host device 101 to communicate securely.

FIG. 1D illustrates an example scenario in which a drone 102 may be configured to carry a hardware security module (HSM) and deliver the HSM to a remote device 105 or alternatively, to another drone 103 which may then deliver the HSM to the remote device 105. As further detailed herein, the HSM may contain a cryptographic key to be used by the remote device 105 to securely communicate with the host device 101.

Accordingly, the present disclosure sets forth systems, methods, and apparatuses that facilitate extended range encrypted communication in a more efficient and secure manner. Although a high level explanation of the operations of example embodiments has been provided above, specific details regarding the configuration of such example embodiments are provided below.

### System Architecture

Example embodiments described herein may be implemented using any of a variety of computing devices or servers. To this end, FIG. 1E illustrates an example environment within which various embodiments may operate. As illustrated, a drone network may comprise a plurality of drones (e.g., drone 102A, 102B, through 102N), wherein each drone may either directly or indirectly communicate with a host device 106. Each drone may include a system device and a storage device. For example, as shown, a first drone 102A may include a system device 104A and a storage device 106A, a second drone 102B may include a system device 104B and a storage device 106B, and a third drone 102N may include a system device 104N and a storage device 106N. Although system devices and storage devices of the drones 102A-102N are described in singular form, drones, in some embodiments, may utilize more than one system device and/or more than one storage device. Additionally, in some embodiments, the drones 102A-N may not require a storage device at all. Whatever the implementation, the drones 102A-N and their constituent system device(s) and/or storage device(s) may receive and/or transmit information via a communications network (e.g., the Internet) with any number of other devices, such as a host device 106 and/or one or more remote devices (e.g., remote devices 108A through 108N).

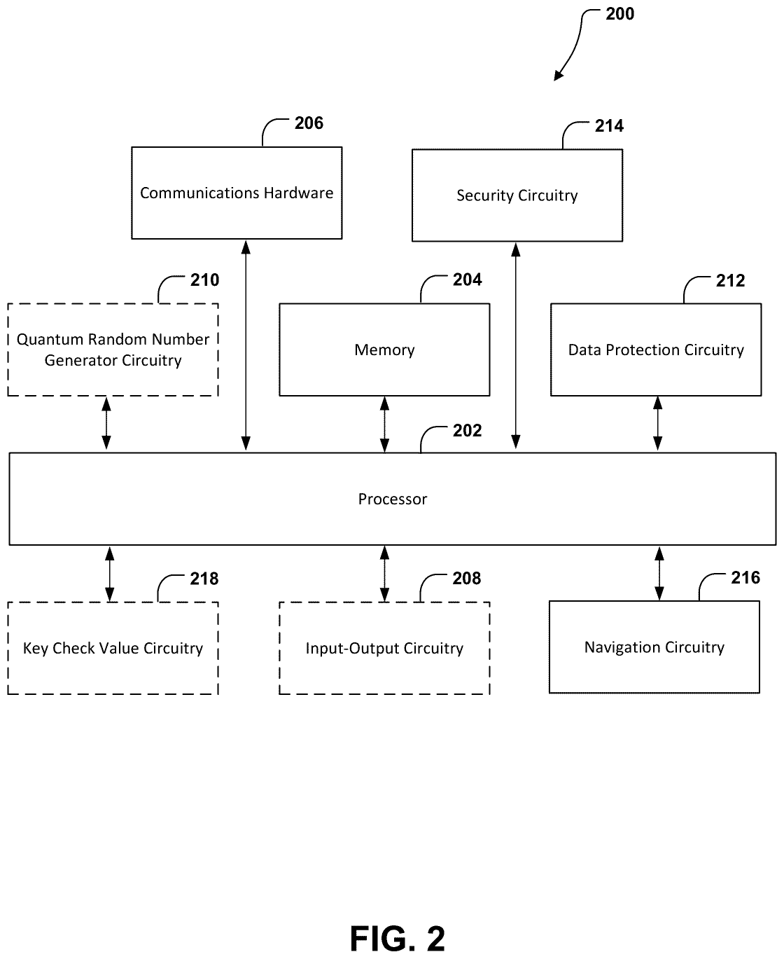

In some examples, some components of system devices (e.g., system devices 104A-N) may be physically proximate to the other components of their respective drones while other components are not. A system device of a drone (e.g., one of drones 102A-N) may receive, process, generate, and transmit data, signals, and electronic information to facilitate the various operations described herein. Particular components of a system device of a drone are described in greater detail below with reference to apparatus 200 in connection with FIG. 2.

A storage device may comprise a distinct component from a drone, or may comprise an element of the drone (e.g., memory 204, as described below in connection with FIG. 2). A storage device may be embodied as one or more direct-attached storage (DAS) devices (such as hard drives, solid-state drives, optical disc drives, or the like). A storage device may host the software executed to operate the drone. A storage device may store information relied upon during operation of the drone, such as various cryptographic keys, key check values, navigation information and/or the like that may be used by the drone, data and files to be analyzed and/or processed using the drone, such as log files, or the like.

The one or more remote devices 108A-N may be embodied by any computing and/or storage devices known in the art. For example, in some embodiments, a remote device may comprise a stationary device, such as an ATM, POS device, and/or other stationary devices. In some embodiments, an example host device 106 may comprise a server device (e.g., a secure data center or other device hosted within the secure network infrastructure of an organization or entity). And while it may be typical to utilize a single host device 106, some embodiments may utilize multiple host devices, such as where each host device is associated with a different host organization or entity. Moreover, it will be understood that the one or more remote devices 108A-N and/or the host device(s) 106 need not be stationary or fixed devices, and need not be devices of any specific kind; rather, in various implementations these devices may be embodied by any computing devices known in the art, such as desktop or laptop computers, tablet devices, smartphones, or the like. Moreover, the one or more remote devices 108A-N and the host device(s) 106 need not themselves be independent devices, but may be peripheral devices communicatively coupled to other computing devices.

### Example Implementing Apparatuses

A drone (e.g., any one of drones 102A-N described previously with reference to FIG. 1E) may be embodied by one or more computing devices, shown as apparatus 200 in FIG. 2. As illustrated in FIG. 2, the apparatus 200 may include processor 202, memory 204, communications hardware 206, input-output circuitry 208, quantum random number generator circuitry 210, data protection circuitry 212, security circuitry 214, navigation circuitry 216, and key check value circuitry 218, each of which will be described in greater detail below. While the various components are only illustrated in FIG. 2 as being connected with processor 202, it will be understood that the apparatus 200 may further comprises a bus (not expressly shown in FIG. 2) for passing information amongst any combination of the various components of the apparatus 200. The apparatus 200 may be configured to execute various operations described above in connection with FIG. 1A-E and below in connection with FIGS. 3-6.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106A-N, as illustrated in FIG. 1E). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means suitable for transmitting data such as cryptographic keys, encrypted data, and/or the like, such as a device or circuitry embodied in either hardware or a combination of hardware and software that is configured to receive and/or transmit data from/to any other device, circuitry, or module in communication with the apparatus 200 (e.g., remote devices 108A-N, other drones 102A-N, and/or host device 106. In this regard, the communications hardware 206 may include, for example, interfaces for enabling communications with other devices, such as one or more ports (e.g., a laser port, a fiber-optic cable port, and/or the like).

In some embodiments, the communications hardware 206 is designed to inject data (e.g., secure cryptographic key(s) into another device (e.g., any of remote devices 108A-N, host devices 106, or one or more drones of a drone network (e.g., any of drones 102A-N). The communications hardware 206 may utilize processor 202, memory 204, and other hardware components included in the apparatus 200 to perform these operations, as described in connection with FIGS. 3-6 below. The communications hardware 206 may further gather data from a variety of sources (e.g., a storage device 106A-N, as shown in FIG. 1E, quantum random number generator circuitry 210, or the like), may utilize input-output circuitry 208 to receive data from a user, and in some embodiments may utilize a transmission medium to inject data into various devices, or otherwise cause transmission of various data.

The apparatus 200 may include input-output circuitry 208 configured to provide output to a user and, in some embodiments, to receive an indication of user input. It will be noted that some embodiments will not include input-output circuitry 208, in which case user input may be received via a separate device such as a remote device 108A-N and/or host device 106 (shown in FIG. 1E). The input-output circuitry 208 may comprise a user interface, such as a display, and may further comprise the components that govern use of the user interface, such as a web browser, mobile application, dedicated client device, or the like. In some embodiments, the input-output circuitry 208 may include a keyboard, a mouse, a touch screen, touch areas, soft keys, a microphone, a speaker, and/or other input/output mechanisms. The input-output circuitry 208 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 may further comprise quantum random number generator circuitry 210 that generates cryptographic keys (e.g., in the form of truly random numbers). In this regard, quantum random number generator circuitry 210 may comprise a quantum random number generator (QRNG) that generates truly random values from a quantum source (e.g., an unpredictable and unaltered entropy source). The quantum random number generator circuitry 210 may utilize processor 202, memory 204, or any other hardware component included in the apparatus 200 to perform these operations, as described in connection with FIGS. 3-6 below. The quantum random number generator circuitry 210 may further utilize communications hardware 206 to gather data from a variety of sources, may utilize input-output circuitry 208 to receive data from a user, and in some embodiments may utilize processor 202 and/or memory 204 to generate a cryptographic key.

In addition, the apparatus 200 also comprises data protection circuitry 212 that performs cryptographic data protection actions using cryptographic keys. The data protection circuitry 212 may utilize processor 202, memory 204, or any other hardware component included in the apparatus 200 to perform these operations, as described in connection with FIGS. 3-6 below. The data protection circuitry 212 may further utilize communications hardware 206 to gather data from a variety of sources, may utilize input-output circuitry 208 to receive data from a user, and in some embodiments may utilize processor 202 and/or memory 204 to encrypt data using a cryptographic key, decrypt encrypted data using a cryptographic key, and/or perform other cryptographic data protection actions.

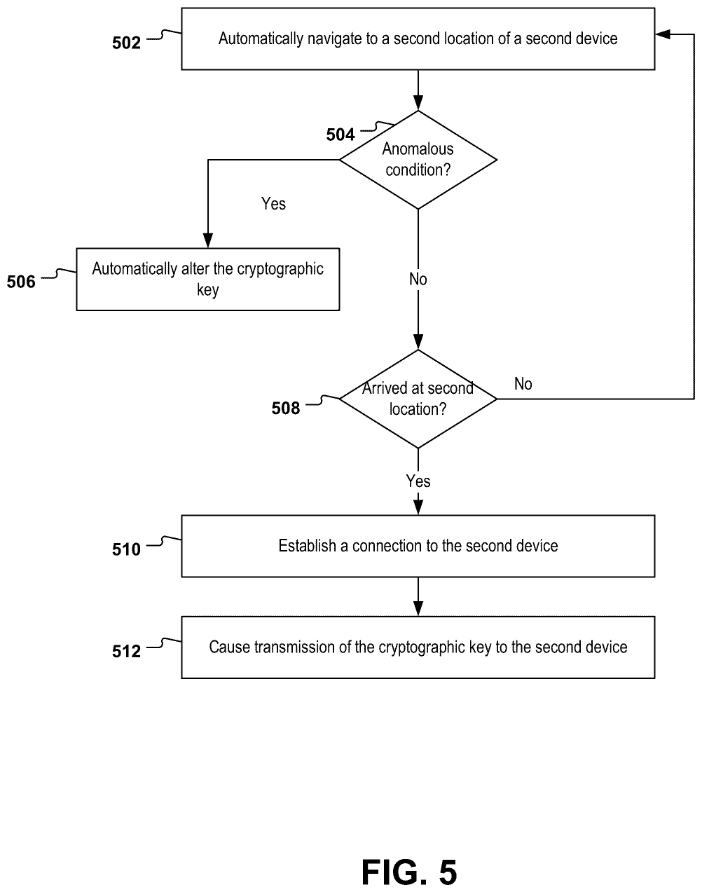

In addition, the apparatus 200 further comprises security circuitry 214 that detects anomalous conditions of a drone and alters cryptographic keys in response to a detection of an anomalous condition. The security circuitry 214 may utilize processor 202, memory 204, or any other hardware component included in the apparatus 200 to perform these operations, as described in connection with FIG. 5 below. The security circuitry 214 may further utilize communications hardware 206 to gather data from a variety of sources, may utilize input-output circuitry 208 to receive data from a user, and in some embodiments may utilize processor 202 and/or memory 204 to detect anomalous conditions and alter cryptographic keys.

In addition, the apparatus 200 may further comprise navigation circuitry 216 that automatically navigates a drone to various locations (e.g., locations of remote devices). In some embodiments, the navigation circuitry 216 may be configured to direct the drone to fly to various locations based on itinerary data received from a host device 106. The navigation circuitry 216 may utilize processor 202, memory 204, or any other hardware component included in the apparatus 200 to perform these operations, as described in connection with FIGS. 3-6 below. The navigation circuitry 216 may further utilize communications hardware 206 to gather data from a variety of sources (e.g., remote devices 108A-N, host devices 106, other drones 102A-N, and/or a storage device 106A-N, as shown in FIG. 1E), may utilize input-output circuitry 208 to receive data from a user, and in some embodiments may utilize processor 202 and/or memory 204 to navigate a drone to various locations.

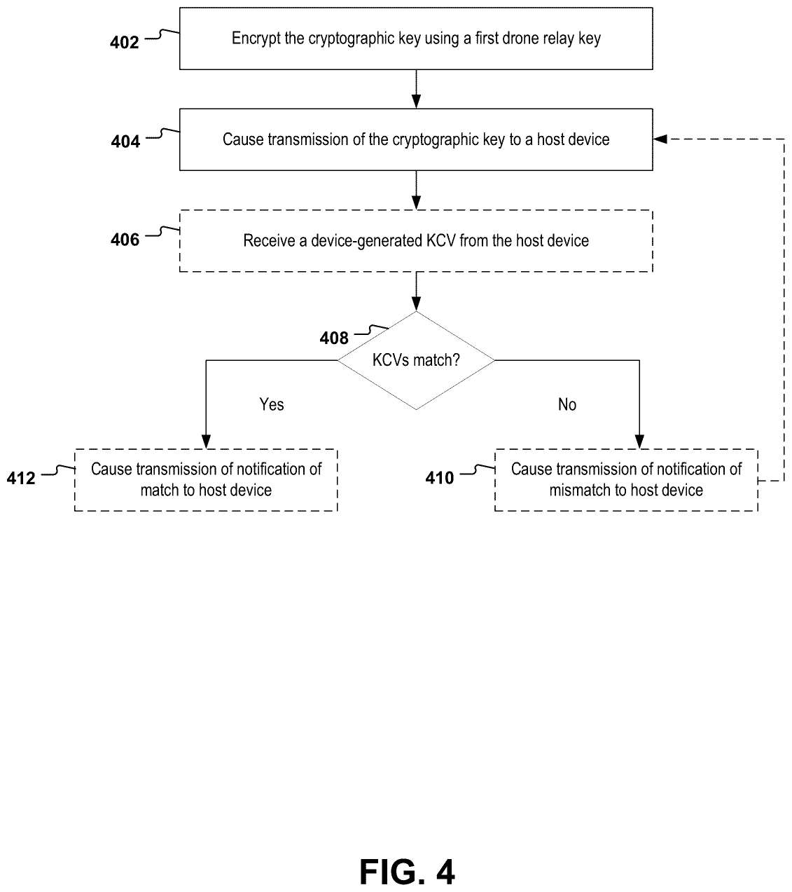

In addition, the apparatus 200 may further comprise key check value circuitry 218 that compares key check values of cryptographic keys and determines whether the key check values match. In some embodiments, the key check value circuitry 218 may be configured to generate key check values. The key check value circuitry 218 may utilize processor 202, memory 204, or any other hardware component included in the apparatus 200 to perform these operations, as described in connection with FIGS. 3-4 below. The key check value circuitry 218 may further utilize communications hardware 206 to gather data from a variety of sources (e.g., host device 106, remote devices 108A-N, other drones 102A-N, and/or storage device 106A-N, as shown in FIG. 1E), may utilize input-output circuitry 208 to receive data from a user, and in some embodiments may utilize processor 202 and/or memory 204 to determine whether a first key check value matches a second key check value.

Although components 202-218 are described in part using functional language, it will be understood that the particular implementations necessarily include the use of particular hardware. It should also be understood that certain of these components 202-218 may include similar or common hardware. For example, the quantum random number generator circuitry 210, data protection circuitry 212, security circuitry 214, navigation circuitry 216, and key check value circuitry 218 may each at times leverage use of the processor 202, memory 204, communications hardware 206, or input-output circuitry 208, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the quantum random number generator circuitry 210, data protection circuitry 212, security circuitry 214, navigation circuitry 216, and key check value circuitry 218 may leverage processor 202, memory 204, communications hardware 206, or input-output circuitry 208 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, communications hardware 206 or input-output circuitry 208 for enabling any functions not performed by special-purpose hardware elements. In all embodiments, however, it will be understood that the quantum random number generator circuitry 210, data protection circuitry 212, security circuitry 214, navigation circuitry 216, and key check value circuitry 218 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the apparatus 200. Thus, some or all of the functionality described herein may be provided by third party circuitry. For example, apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by apparatus 200. Furthermore, some example embodiments may utilize one or more computer program product comprising software instructions stored on at least one non-transitory computer-readable storage medium (e.g., memory 204) that, when executed, cause execution of the functionality of various components of a respective apparatus 200. Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2 that loading the software instructions onto a computing device or apparatus produces a special-purpose machine comprising the means for implementing any corresponding functions described herein.

Having described specific components of example apparatus 200, example embodiments are described below in connection with a series of flowcharts.

### Example Operations

Turning to FIGS. 3-5, example flowcharts are illustrated that contain example operations implemented by example embodiments described herein. The operations illustrated in FIGS. 4-6 may, for example, be performed by a drone (e.g., drone 102A shown in FIG. 1E, which may in turn be embodied by an apparatus 200, which is shown and described in connection with FIG. 2. To perform the operations described below, the apparatus 200 may utilize one or more of processor 202, memory 204, communications hardware 206, input-output circuitry 208, quantum random number generator circuitry 210, data protection circuitry 212, security circuitry 214, navigation circuitry 216, key check value circuitry 218, and/or any combination thereof.

In some embodiments, a host device (e.g., host device 106, as described above in connection with FIG. 1E) may be in communication with one or more drones of a drone network (e.g., drones 102A-N). In some embodiments, the host device 106 may provide one or more cryptographic keys to the various drones of the drone network. In some embodiments, a host device 106 may generate and provide a communal drone relay key to a plurality of drones of the drone network. In this regard, the apparatus 200 includes means, such as processor 202, memory 204, communications hardware 206, and/or the like, for receiving a communal drone relay key. A communal drone relay key may be a cryptographic key that is used by the plurality of drones and the host device to securely communicate messages. In some embodiments, the plurality of drones with which the communal drone relay key is shared may include all drones of the drone network. Alternatively, in some embodiments, the plurality of drones with which the communal drone relay key is shared may include a subset of drones of the drone network. In some embodiments, the host device 106 may use the communal drone relay key to encrypt data and broadcast the encrypted data to drones of the drone network (e.g., all drones or a subset of drones of the drone network). In this regard, drones possessing the communal drone relay key are able to decrypt and further process the data, while drones receiving the encrypted data but not possessing the communal drone key are unable to decrypt the data.

In some embodiments, a host device 106 may generate and provide a unique drone relay key a drone of the drone network. In this regard, the apparatus 200 includes means, such as processor 202, memory 204, communications hardware 206, and/or the like, for receiving a drone relay key. A drone relay key may be a cryptographic key that is known only to the host device and a single drone of the drone network. A drone relay key may be used by the drone and the host device to securely communicate messages. In some embodiments, the host device 106 may use the drone relay key to encrypt data and broadcast the encrypted data to drones (e.g., all drones) of the drone network. In this regard, only the single drone possessing the unique drone relay key used to encrypt the message is able to decrypt and further process the data, while drones receiving the encrypted data but not possessing the particular drone key are unable to decrypt the data. As further described herein, in some embodiments, a drone may use its unique drone relay key to encrypt data such as a cryptographic key(s) provided to a remote device(s) 108A-N and transmit the encrypted data back to the host device 106, such that the host device can securely obtain the keys provided to the remote devices without other drones being made aware of the keys.

As described further below, in some embodiments, a drone may travel to a remote device and, upon arriving the remote device, generate a cryptographic key to be provided to the remote device. However, in some other embodiments, a drone may first receive a cryptographic key (which is to be provided to a remote device) from a host device 106. In this regard, the apparatus 200 includes means, such as processor 202, memory 204, communications hardware 206, and/or the like, for receiving a cryptographic key from a host device. For instance, rather than a drone generating a cryptographic key for a remote device (e.g., via an onboard QRNG), the host device may generate the cryptographic key itself (e.g., via an in-house QRNG) and provide it to the drone, after which the drone may travel to the remote device and provide the cryptographic key to the remote device.

Regardless of whether the host device or the drone generates the cryptographic key for the remote device, the drone may receive itinerary data for traveling to one or more locations of remote devices. For example, itinerary data may include instructions comprising geolocations of remote device(s) (e.g., global positioning system (GPS) coordinates), specific routes to take to arrive at the location of the remote device(s), instructions on which cryptographic key(s) to provide to the remote device(s) (e.g., in instances in which the host device 106 generates and provides the cryptographic keys to the drone), and/or the like. The drone may use the itinerary data to navigate autonomously to one or more locations of remote devices. In this regard, the apparatus 200 includes means, such as processor 202, memory 204, communications hardware 206, and/or the like, for receiving itinerary data. In some embodiments, a drone may receive itinerary data from a host device 106. In some embodiments, a drone may receive itinerary data from another drone of the drone network. In this regard, a first drone may relay itinerary data originally received from a host device 106 to another drone (or multiple other drones) of the drone network.

Turning first to FIG. 3, example operations are shown for facilitating extended range encrypted communication. As shown by operation 302, the apparatus 200 includes means, such as processor 202, memory 204, navigation circuitry 216, and/or the like, for automatically navigating to a first location of a first device. As noted above, the drone may utilize itinerary data received from a host device (or another drone) to navigate to the first location of the first device (e.g., a remote device 108A-N). In some embodiments, the location of the remote device may be within a region that is only safely accessible by a drone. In this regard, the remote device may be located in a war-torn region, in an area incurring extreme environmental conditions, and/or in an area otherwise extremely difficult to reach by a human (e.g., within a mountainous region, in remote Alaska, and/or the like). The drone may navigate to the remote device autonomously using the itinerary data. As mentioned above, the drone may be an unmanned aerial vehicle, such that the drone is capable of flying to the location of the remote device.

As shown by operation 304, the apparatus 200 includes means, such as processor 202, memory 204, quantum random number generator circuitry 210, and/or the like, for generating a cryptographic key. The cryptographic key may be generated for the purpose of providing the cryptographic key to the remote device. The drone may leverage an onboard QRNG that utilizes a quantum source to generate the cryptographic key, such that the cryptographic key is a truly random number. In some embodiments, the drone may generate the cryptographic key after arriving at the first location. In this regard, the drone may generate the cryptographic in response to arriving at the remote device. The drone may generate the cryptographic key only after having arrived at the remote device to avoid any potential eavesdropping or other interference by third-party actors while the drone is traveling to the remote device.

In some embodiments, after generating the cryptographic key, the drone may optionally generate a key check value (KCV) based on the cryptographic key. As shown by operation 306, the apparatus 200 includes means, such as processor 202, memory 204, key check value circuitry 218, and/or the like, for generating a key check value based on the cryptographic key. In some embodiments, drones of the drone network, remote devices, and a host device(s) may utilize KCVs in order to verify accuracy of data transmitted between various devices. A KCV is a non-secret value that is cryptographically derived from a cryptographic key and is used to verify that the underlying value is as expected. For example, in some embodiments and as further described below, once the cryptographic key is received at the remote device from the drone, the remote device may provide a KCV that is based on the cryptographic key to the drone. In some embodiments, the KCV may represent data associated with the cryptographic key itself. For example, the KCV may be a hash value of the cryptographic key. In this regard, the drone may compare the hash value generated by the drone to the hash value generated by and received from the remote device to confirm that the hashes match and that the remote device successfully received the cryptographic key. In other words, the drone may confirm that no errors were involved when causing transmission of the cryptographic key to the remote device.

As shown by operation 308, the apparatus 200 includes means, such as processor 202, memory 204, communications hardware 206, and/or the like, for establishing a first connection to the first device (e.g., a remote device 108A-N). For example, the drone may travel to a first device and automatically establish a connection to the first device. The first device may be any type of device. For example, the first device may be a stationary device, such as an ATM, POS terminal, and/or other stationary device. In some embodiments, the first device may be another drone of the drone network. In some embodiments, a connection between the drone and the first device may be established using communications hardware 206 interacting with corresponding communications hardware of the remote device. For example, the connection may be a physical connection, such as via a fiber-optic cable. As another example, the connection may be a laser connection. In some embodiments, the connection may a wireless connection, such that the connection may be established via a secure spectrum, channel, or the like.

Once the connection is established between the drone and the first device, the cryptographic key may then be injected into the first device. As shown by operation 310, the apparatus 200 includes means, such as processor 202, memory 204, communications hardware 206, and/or the like, for causing transmission of the cryptographic key to the first device.

In some embodiments, the drone may optionally then receive a KCV from the remote device. The remote device may generate a KCV based on the cryptographic key received from the drone. In this regard, as shown by operation 312, the apparatus 200 includes means, such as processor 202, memory 204, communications hardware 206, and/or the like, for receiving a device-generated KCV from the remote device. As mentioned above, the KCV may comprise a hash of the cryptographic key. As shown by decision point 314, the apparatus 200 includes means, such as processor 202, memory 204, key check value circuitry 218, and/or the like, for determining whether a first key check value matches a second key check value. For instance, the drone may compare the key check value generated by the drone (based on the cryptographic key generated by the drone) to the key check value generated by the remote device (based on the cryptographic key received by the remote device from the drone) to ensure that the KCVs are the same (i.e., no errors were involved when causing transmission of the cryptographic key to the remote device that caused an alteration to the cryptographic key).

In an instance in which the KCVs do not match, the method may continue to operation 316, wherein the apparatus 200 includes means, such as processor 202, memory 204, communications hardware 206, and/or the like, for causing transmission of a notification of the mismatch of KCVs to the first device. In this regard, the device is notified that the cryptographic key is received is not the correct cryptographic key, and that another cryptographic key will need to be provided to the device. The method may then return to operation 304, wherein the drone generates another cryptographic key and provides the key to the remote device. This process may continue until matching KCVs are determined.

In an instance in which the KCVs match, the method may continue to operation 318, wherein the apparatus 200 includes means, such as processor 202, memory 204, communications hardware 206, and/or the like, for causing transmission of a notification of the match of KCVs to the first device. In this regard, the device is notified that the cryptographic key is received is the correct cryptographic key. The method may then continue on to FIG. 4.

Turning to FIG. 4, as shown by operation 402, the apparatus 200 includes means, such as processor 202, memory 204, data protection circuitry 212, and/or the like, for encrypting the cryptographic key using a first drone relay key. In this regard, once the drone has successfully provided the cryptographic key to the remote device, the drone may then provide the cryptographic key to the host device. To do so, the drone may encrypt the cryptographic key with its unique drone relay key (e.g., provided to the drone by the host device 106 as described above). In this regard, the drone relay key in effect serves as a key encryption key (KEK) for the cryptographic key.

As shown by operation 404, the apparatus 200 includes means, such as processor 202, memory 204, communications hardware 206, and/or the like, for causing transmission of the cryptographic key to the host device. As only the drone and the host device possesses the unique drone relay key, the host device is the only device able to decrypt and obtain the cryptographic key.

While the flowchart of FIG. 4 illustrates operations wherein the drone utilizes a unique drone relay key to encrypt the cryptographic key and causes transmission of the encrypted cryptographic key to a host device, it is to be appreciated that other methods of providing the cryptographic key to the host device may be employed. For example, after having successfully provided the cryptographic key to the remote device, in some embodiments, the drone may navigate to the host device and inject the cryptographic key into the host device (e.g., via a physical or secure wireless connection similar to the connection established between the drone and the remote device).

Regardless of the method of delivery of the cryptographic key to the host device, in some embodiments, the host device may generate a KCV based on the cryptographic key in response to receiving the cryptographic key from the drone. In this regard, as shown by operation 406, the apparatus 200 includes means, such as processor 202, memory 204, communications hardware 206, and/or the like, for receiving a device-generated KCV from the host device. As mentioned above, the KCV may comprise a hash of the cryptographic key. As shown by decision point 408, the apparatus 200 includes means, such as processor 202, memory 204, key check value circuitry 218, and/or the like, for determining whether a first key check value matches a second key check value. For instance, the drone may compare the key check value generated by the drone (based on the cryptographic key generated by the drone) to the key check value generated by the host device (based on the cryptographic key received by the host device from the drone) to ensure that the KCVs are the same.

In an instance in which the KCVs do not match, the method may continue to operation 410, wherein the apparatus 200 includes means, such as processor 202, memory 204, communications hardware 206, and/or the like, for causing transmission of a notification of the mismatch of KCVs to the host device. In this regard, the host device is notified that the cryptographic key is received is not the correct cryptographic key. In some embodiments, the method may then return to operation 404, wherein the drone again causes transmission of the cryptographic key to the host device. This process may continue until matching KCVs are determined.

In an instance in which the KCVs match, the method may continue to operation 412, wherein the apparatus 200 includes means, such as processor 202, memory 204, communications hardware 206, and/or the like, for causing transmission of a notification of the match of KCVs to the host device. In this regard, the host device is notified that the cryptographic key is received is the correct cryptographic key.

Once the host device and the remote device each possess the cryptographic key, the cryptographic key can be used to facilitate secure communication between the host device and the remote device. In this regard, the host device can encrypt data using the cryptographic key and transmit the encrypted data to the remote device. The remote device can then decrypt the encrypted data using the cryptographic key in order to obtain and further process the data.

In some embodiments, the drone may navigate to multiple locations of multiple remote devices. For instance, following an injection of a cryptographic key into a first device (and optionally a subsequent transmission of the cryptographic key to the host device), the drone may navigate to another location of another device.

Turning to FIG. 5, as shown by operation 502, the apparatus 200 includes means, such as processor 202, memory 204, navigation circuitry 216, and/or the like, for automatically navigating to a second location of a second device. As noted above, the drone may utilize itinerary data received from a host device (or another drone) to navigate to the second location of the second device (e.g., another remote device 108A-N, or another drone 102A-N).

In some embodiments, the drone may travel to a second device in order to generate and cause transmission of another cryptographic key (e.g., a cryptographic key different from the cryptographic key injected into the first remote device) to the second device. However, in some embodiments, the drone may travel to the second device in order to cause transmission of the same cryptographic key (provided to the first device) to the second device. In this regard, the drone may traverse some distance while possessing the cryptographic key (i.e., having the cryptographic key stored (e.g., in memory 204, storage device 106A, or the like)). To combat potential eavesdropping or unauthorized access of the cryptographic key during travel, the drone may comprise security circuitry that is configured to detect anomalous conditions of the drone and, if necessary, alter the cryptographic key to avoid the key being compromised.

As shown by decision point 504, the apparatus 200 includes means, such as processor 202, memory 204, security circuitry 214, and/or the like, for detecting an anomalous condition of the first drone. The anomalous condition may be detected based on a variety of factors. As one example, an anomalous condition may be detected in an instance in which the drone has deviated from a route defined by the itinerary data. As another example, an anomalous condition may be detected in an instance in which an unknown device has connected to or is attempting to connect to the drone (e.g., via the communications hardware 206 or input-output circuitry 208 of the drone).

In an instance in which an anomalous condition is detected, the method may continue to operation 506, wherein the apparatus 200 includes means, such as processor 202, memory 204, security circuitry 214, and/or the like, for automatically altering the cryptographic key. The cryptographic key may be automatically altered in response to detecting the anomalous condition. In some embodiments, altering the cryptographic key may comprise zeroizing the cryptographic key (e.g., setting all digits of the cryptographic key to zero). In some embodiments, altering the cryptographic key may comprise scrambling the digits of the cryptographic key. In some embodiments, altering the cryptographic key may comprise deleting the cryptographic key.

In some embodiments, if an anomalous condition has not been detected, the method continues to decision point 508, wherein the apparatus 200 includes means, such as processor 202, memory 204, navigation circuitry 216, and/or the like, for determining whether the drone has arrived at the second location. If the drone has not yet arrived at the second location, the method may return to operation 502, wherein the drone continues to navigate to the second location while continuing to monitor for potential anomalous conditions.

In an instance in which it is determined that the drone has arrived at the second location, the method may continue to operation 510, wherein the apparatus 200 includes means, such as processor 202, memory 204, communications hardware 206, and/or the like, for establishing a connection to the second device. As noted above, in some embodiments, a connection between the drone and the device may be established using communications hardware 206 interacting with corresponding communications hardware of the remote device. For example, the connection may be a physical connection, such as via a fiber-optic cable. As another example, the connection may be a laser connection. In some embodiments, the connection may a wireless connection, such that the connection may be established via a secure spectrum, channel, or the like.

As shown by operation 512, the apparatus 200 includes means, such as processor 202, memory 204, communications hardware 206, and/or the like, for causing transmission of the cryptographic key to the second device. Following transmission of the cryptographic key to the second device, the drone may perform additional operations similar to operations 314-316 of FIG. 3 wherein the drone may receive a device-generated KCV from the second device and confirm that the device generated KCV matches the KCV for the cryptographic key generated by the drone.

Although the flowcharts of FIGS. 3-5 describe operations pertaining to a single drone, it is to be appreciated that multiple drones of the drone network may be employed to deliver a cryptographic key to a remote device. For example, in circumstances in which the remote device is located a significant distance away (e.g., too far for a single drone to travel without experiencing battery life issues or the like), a first drone may instead deliver a cryptographic key to a second drone stationed closer to the remote device. The second drone may then continue on to deliver the cryptographic key to the remote device (or alternatively, deliver the cryptographic key to a third drone, which may then deliver the cryptographic key to the remote device).

Further, although the operations of FIGS. 3-5 describe a drone having an onboard QRNG (e.g., quantum random number generator circuitry 210), in some example embodiments, drones of the drone network may not possess an onboard QRNG. Rather, drones of the drone network may be configured to carry an HSM storing the cryptographic key and deliver the HSM to a location of the remote device. In this regard, the cryptographic key is never exposed to a memory of the drone, but rather, is secured in the HSM which the drone carries to the remote location. For example, a cryptographic key known to the host device may be injected into the HSM within a KIF. The HSM may then be physically attached to the drone, and the drone may then navigate to the remote device (or another drone) and deliver the HSM.

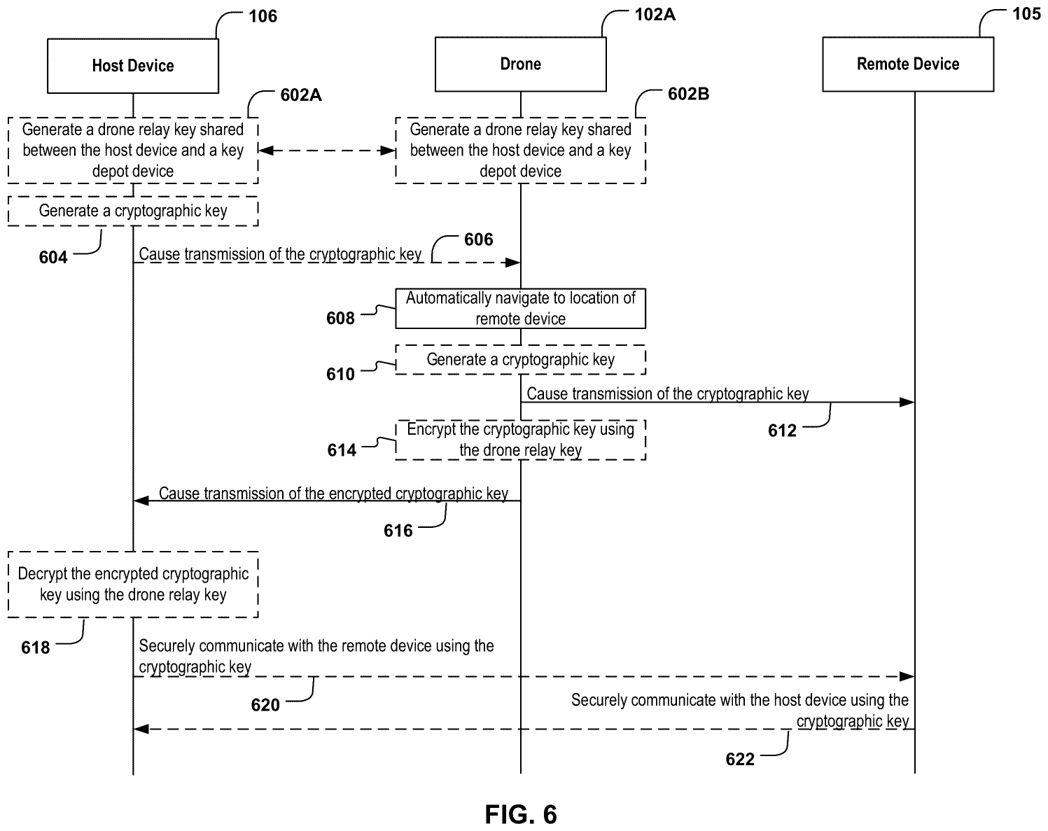

FIG. 6 shows a swim lane diagram illustrating example operations (e.g., as described above in connection with FIGS. 3-5) performed by components of the environment depicted in FIG. 1E to product various benefits from example embodiments. In these figures, operations performed by a host device 106 are shown along the line extending from the box labeled “host device,” operations performed by a drone 102A are shown along the line extending from the box labeled “drone,” and operations performed by a remote device 105 are shown along the line extending from the box labeled “remote device.” Generally, the operations are ordered temporally with respect to one another. However, it will be appreciated that the operations may be performed in other orders from those illustrated herein.

At operation 602A, the host device 106 generates a drone relay key and shares the drone relay key with the drone. Alternatively, at operation 602B, the drone 102A may instead generate the drone relay key (e.g., via an onboard QRNG) and share the drone relay key with the host device 106. Optionally at operation 604, in some embodiments, the host device 106 may generate a cryptographic key. At operation 606, the host device 106 may optionally cause transmission of the cryptographic key to the drone 102A.

At operation 608, the drone may automatically navigate to the location of the remote device. At operation 610, the drone, upon arriving at the location of the remote device, may then generate a cryptographic key (e.g., in an instance in which the host device has not provided the drone with a cryptographic key as shown in operation 604). At operation 612, the drone causes transmission of the cryptographic key to the remote device 105.

At operation 614, the drone encrypts the cryptographic key using the drone relay key. At operation 616, the drone then causes transmission of the encrypted cryptographic key to the host device 106. At operation 618, the host device decrypts the cryptographic key using the drone relay key. Once the host device 106 and remote device 105 each possess the cryptographic key, the devices may then use the cryptographic key to securely communicate with each other. In this regard, as shown by operation 620, the host securely communicates with the remote device using the cryptographic key. At operation 622, the remote device securely communicates with the host device using the cryptographic key.

As described above, example embodiments provide methods and apparatuses that facilitate extended range encrypted communication and mitigate the issues faced by both traditional quantum-based key distribution systems and traditional key exchange protocols reliant on KLDs. Example embodiments thus provide tools that overcome the problems faced by traditional forms of cryptographic key distribution, and do so by leveraging a connected drone network capable of generating and securely delivering cryptographic keys over great distances and to devices which may not be otherwise accessible by a human. By avoiding the need for a human to physically transport keys over a distance, example embodiments significantly reduce the risk of man-in-the-middle attacks that has been unavoidable in the past when using KLD key delivery procedures. Additionally, by automating functionality such as key matching confirmation (e.g., through use of key check values) that has historically required manual human analysis, the speed and consistency of the evaluations performed by example embodiments unlocks many potential new functions that have historically not been available, such as the ability to conduct faster cyberattack detection.

As these examples all illustrate, example embodiments contemplated herein provide technical solutions that solve real-world problems faced during cryptographic key distribution. And while the shortcomings of traditional key exchange tools have been an issue, the improved networking of modern telecommunications technology and the trend towards distributed storage and use of data in an open environment rather than within internal networks have made this problem significantly more acute, and the demand for quantum-based solutions for data security has grown significantly. Example embodiments described herein thus represent a technical solution to these real-world problems.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for facilitating extended range encrypted communication, the method comprising:
automatically navigating, via navigation circuitry of a first drone, to a first location of a first device;
generating, by quantum random number generator circuitry of the first drone, a cryptographic key;
generating, by key check value circuitry of the first drone, a first key check value based on the cryptographic key;
establishing, by communications hardware of the first drone, a first connection between the first drone and the first device;
causing transmission, by the communications hardware of the first drone, of the cryptographic key to the first device, such that the cryptographic key facilitates secure communication between the first drone and the first device;
receiving, by the communications hardware of the first drone, a second key check value from the first device, the first device having generated the second key check value based on the cryptographic key received from the first drone;
determining, by the key check value circuitry of the first drone, that the first key check value matches the second key check value; and
causing, by the communications hardware of the first drone, transmission of a notification of a match between the first key check value and the second key check value to the first device.

2. The method of claim 1, further comprising:
causing transmission, by the communications hardware of the first drone, of the cryptographic key to a host device, such that the cryptographic key facilitates secure communication between the host device and the first device.

3. The method of claim 2, further comprising:
encrypting, by data protection circuitry of the first drone, the cryptographic key using a first drone relay key prior to causing transmission of the cryptographic key to the host device, wherein the first drone relay key is known to the host device.

4. The method of claim 1, wherein the first device is a second drone.

5. The method of claim 4, wherein the second drone is configured to deliver the cryptographic key to at least one other device.

6. The method of claim 1, wherein the cryptographic key is generated after arriving at the first location.

7. The method of claim 1, further comprising:
automatically navigating, via navigation circuitry of the first drone, to a second location of a second device.

8. The method of claim 7, further comprising:
establishing, by the communications hardware of the first drone, a second connection between the first drone and the second device; and
causing transmission, by the communications hardware of the first drone, of the cryptographic key to the second device,
wherein the cryptographic key facilitates secure communication between the first device and the second device.

9. The method of claim 7, further comprising:
generating, by the quantum random number generator circuitry of the first drone, a second cryptographic key;
establishing, by the communications hardware of the first drone, a second connection between the first drone and the second device; and
causing transmission, by the communications hardware of the first drone, of the second cryptographic key to the second device, such that the second cryptographic key facilitates secure communication between the first drone and the second device.

10. The method of claim 9, further comprising:
causing transmission, by the communications hardware of the first drone, of the second cryptographic key to a host device, such that the second cryptographic key facilitates secure communication between the host device and the second device.

11. The method of claim 1, further comprising:
detecting, via security circuitry of the first drone, an anomalous condition of the first drone; and
in response to detecting the anomalous condition, automatically altering, by the security circuitry of the first drone, the cryptographic key.

12. An apparatus for facilitating extended range encrypted communication, the apparatus comprising:
navigation circuitry of a first drone configured to automatically navigate to a first location of a first device;
quantum random number generator circuitry of the first drone configured to generate a cryptographic key;
key check value circuitry of the first drone configured to generate a first key check value based on the cryptographic key; and
communications hardware of the first drone configured to:
establish a first connection between the first drone and the first device,
cause transmission of the cryptographic key to the first device, such that the cryptographic key facilitates secure communication between the first drone and the first device, and
receive a second key check value from the first device, the first device having generated the second key check value based on the cryptographic key received from the first drone,
wherein the key check value circuitry of the first drone is further configured to determine that the first key check value matches the second key check value, and
wherein the communications hardware of the first drone is further configure to cause transmission of a notification of a match between the first key check value and the second key check value to the first device.

13. The apparatus of claim 12, wherein the communications hardware is further configured to:
cause transmission of the cryptographic key to a host device, such that the cryptographic key facilitates secure communication between the host device and the first device.

14. The apparatus of claim 13, further comprising:
data protection circuitry configured to encrypt the cryptographic key using a first drone relay key prior to causing transmission of the cryptographic key to the host device, wherein the first drone relay key is known to the host device.

15. The apparatus of claim 12, wherein the first device is a second drone.

16. The apparatus of claim 15, wherein the second drone is configured to deliver the cryptographic key to at least one other device.

17. The apparatus of claim 12, wherein the quantum random number generator circuitry generates the cryptographic key after arriving at the first location.

18. The apparatus of claim 12, wherein the navigation circuitry is further configured to:
automatically navigate to a second location of a second device.

19. The apparatus of claim 18, wherein the communications hardware is further configured to:
establish a second connection between the first drone and the second device; and
cause transmission of the cryptographic key to the second device,
wherein the cryptographic key facilitates secure communication between the first device and the second device.

20. The apparatus of claim 18, further comprising:
generating, by the quantum random number generator circuitry of the first drone, a second cryptographic key;
establishing, by the communications hardware of the first drone, a second connection between the first drone and the second device; and
causing transmission, by the communications hardware of the first drone, of the second cryptographic key to the second device, such that the second cryptographic key facilitates secure communication between the first drone and the second device.

21. The apparatus of claim 20, wherein the communications hardware is further configured to:
cause transmission of the second cryptographic key to a host device, such that the second cryptographic key facilitates secure communication between the host device and the second device.

22. The apparatus of claim 12, further comprising:
security circuitry of the first drone configured to:
detect an anomalous condition of the first drone; and
automatically alter the cryptographic key in response to detecting the anomalous condition.
